(19) United States
(12) Patent Application Publication
(10) Pub. No.: US 2025/0089708 A1
(43) Pub. Date: Mar. 20, 2025

(54) BOTANICAL DISINFECTING, CLEANING, AND DEODORIZING FORMULATION AND METHOD OF USE

(71) Applicant: Jerry R. BOND, Flowery Branch, GA (US)

(72) Inventor: Jerry R. BOND, Flowery Branch, GA (US)

(21) Appl. No.: 18/368,196

(22) Filed: Sep. 14, 2023

(51) Int. Cl. A01N 37/02; A01N 31/02; A01N 65/06; A01N 65/16; A01N 65/22; A01P 1/00

(52) U.S. Cl. CPC A01N 37/02; A01N 31/02; A01N 65/06; A01N 65/16; A01N 65/22; A01P 1/00

(57) ABSTRACT

An all 25(b) botanical cleaner/disinfectant/deodorizer formulation contains effective amounts of the ingredients of citric acid, isopropanol, a surfactant such as sodium lauryl sulfate, wintergreen oil, thyme oil, and cedarwood oil. The ingredients combined with water to produce a clear microemulsion for application as a cleaner/disinfectant. Areas of treatment can include hospitals, homes, construction sites, open areas outside, laboratories, and the like.

### FIELD OF THE INVENTION

The invention relates to a botanical formulation that can clean, disinfectant, and deodorize, and, particularly acts as a bactericide, virucide and mildicide. The botanical formulation is made up of components that are all FIFRA 25(b) compliant, making it a formulation that is 100% minimal risk in terms of its components.

### BACKGROUND ART

There are many types of formulations that are used for cleaning and disinfection purposes in the prior art. One type employs copper sulfate as the active antibacterial component. Another is based on a synthetic thyme oil product called Thymox. Neither of these products is a natural product that can be characterized as a minimum risk formulation that is exempt from registration under the Federal Insecticide, Fungicide, and Rodenticide Act (FIFRA). An EPA 25(b) product is one whose active and inactive ingredients are only those found on the EPA's listing, which are attached as Tables 1 and 2. Information in this regard can also be gleaned from https://www.epa.gov/minimum-risk-pesticides, the information herein incorporated herein by reference for understanding of the invention.

U.S. Pat. No. 11,284,624 to Bond discloses a microemulsion formulation that is made up of all 25(b) components and has application as a cleaner/disinfectant. This formulation also can be used to treat growing and harvested crops for pesticide purposes, suppress dust, and disrupt and/or remove bioaerosols in the air.

However, there is still a need to provide formulations with improved disinfecting properties against bacteria, viruses, and fungi, while qualifying as a 100% FIFRA 25(b) minimal risk formulation. The present invention responds to this need by providing a 100% FIFRA 25(b) minimal risk formulation that has unexpectedly superior disinfection, virucidal, and fungicidal performance.

### SUMMARY OF THE INVENTION

One object of the invention is a formulation that has a number of applications in the fields of cleaning and/or disinfecting surfaces, particularly hard and non-porous surfaces, and the like by applying the formulation to the surface in an effective amount for cleaning and/or disinfection purposes.

The formulation is a 100% FIFRA 25(b) minimal risk formulation. This means that all of the component parts of the formulation are all recognized as minimal risk components as designated by the EPA and FIFRA, see Tables 1 and 2 as found below.

One embodiment of the invention is a formulation for disinfecting, cleaning, and deodorizing and comprising, in weight percent:
citric acid (50% active) in an amount ranging from about 3.78 to about 4.53%;
isopropanol (100% active) in an amount ranging from about 16.59 to about 20.27%;
sodium lauryl sulfate (30% active) in an amount ranging from about 4.5 to 5.5%;
wintergreen oil in an amount ranging from about 0.207 to about 0.253%;
thyme oil in an amount ranging from about 0.17 to about 0.21%;
cedarwood oil in an amount ranging from about 0.027 to about 0.033%; and
water in an amount ranging from 64.8 to 79.2%.

The formulation can have pH in a range between 6.0 and 8.0.

A more preferred composition for the formulation is wherein the citric acid (50% active) ranges from about 3.92 to about 4.32%, the isopropanol (100% active) ranges from about 17.51 to about 19.36%, the sodium lauryl sulfate (30% active) ranges from about 4.75 to about 5.25%. and the water ranges from about 69.84 to about 77.16%.

A most preferred composition for the formulation is wherein the citric acid (50% active) is 4.12%, the isopropanol (100% active) is 18.43%, the sodium lauryl sulfate (30% active) is 5.0%, the wintergreen oil is 0.23%, the thyme oil is 0.19%, the cedarwood oil is 0.03% and water is 72%.

The formulation has a greater than or equal to 6 log reduction against Pseudomonas aeruginosa (ATCC 15442), Salmonella enterica (ATCC 10708), and Staphylococcus aureus (ATCC 6538) and has a greater than or equal to 5 log reduction against Human Corona Virus (ATCCVR-740), Norovirus ((Norwalk-like Virus))((Feline Calicivirus)) {(VR-782), Polio Virus Type 1 (ATCC VR-1562), SARS-Related Coronaviius 2 (SARS-CoV-2), and Trichophyton mentagrophytes (ATCC 9533). Put another way, the formulation has a total kill for the bacteria in 10 minutes on hard non-porous surfaces, a total kill for the Human Corona Virus (ATCCVR-740), Norovirus ((Norwalk-like Virus))((Feline Calicivirus)) ((VR-782), Polio Virus Type 1 (ATCC VR-1562) in 5 minutes on hard non-porous surfaces, and a total kill in 90 seconds for SARS-Related Coronavirus 2 (SARS-CoV-2), and a total kill in 10 minutes for the Trichophyton mentagrophytes (ATCC 9533)

Preferably, the formulation is in the form of a microemulsion and is clear in nature.

The invention also includes a method of using the formulation for the purpose of disinfecting, cleaning, and/or deodorizing hard non-porous surfaces. Virtually any hard non-porous surface that is in need of disinfection, deodorizing, cleaning, and/or degreasing is a candidate surface for application of the formulation. The surface can be virtually any surface in need of cleaning or disinfecting and these surfaces include metal, plastic, wood, masonry, composite material, and the like and examples of the types of surfaces, areas of application and effects of the formulation are described in more detail below.

The formulation can be applied in virtually any known way that disinfecting, deodorizing, and cleaning formulations are used on hard non-porous surfaces. Examples, include one or more of brushing, wiping using an implement like a sponge, rag, paper towel, or the like, spraying, foaming, and brooming.

The formulation can be used as is or can be diluted by the addition of more water if so desired. The degree of dilution can vary depending on the application, with less dilution for applications requiring a heavier duty type of cleaning that may not require the full concentration of the formulation. Examples of dilution rates range from 1 ounce of formulation to up to 16 ounces per gallon of water, with more preferred dilution rate ranges being 2 to 6 ounces per gallon of water and 2 to 4 ounces per gallon of water. The dilution should be an effective amount of water that still allows the formulation to be effective in terms of the intended purpose of application, cleaning, deodorizing, and/or degreasing. Preferably, the formulation is used at full strength for disinfection and diluted when only cleaning is required.

All components of the formulation are listed on the EPA active and inactive ingredients eligible for minimum risk pesticide products.

### DETAILED DESCRIPTION OF THE INVENTION

The inventive formulation is improved over other prior art formulations particularly by its ability to effectively kill bacteria and viruses in accordance with EPA standards for disinfection. The formulation is preferably formulated as a clear microemulsion. The pH is preferably controlled in a proper range for effective cleaning and anti-bacterial capability.

Table A below shows the components of the formulation, the components CAS number, the range in terms of weight percent and pounds.

TABLE A

| A | | C | D | E | F |
|---|---|---|---|---|---|
| Components in | B | % by | Upper | Lower | Purpose in |
| Formulation | Amount | weight | Limit | Limit | Formulation |
| Citric Acid (50% | 4.12 (2.06) | 4.12 (2.06) | 4.32 (2.16) | 3.92 (1.96) | Active |
| Active), CAS# 77-92-9 | | | | | |
| Isopropanol (100%) | 18.43 | 18.43 | 19.35 | 17.51 | Solvent |
| CAS# 67-63-0 | | | | | |
| Sodium Lauryl Sulfate | 5.00 (1.50) | 5.00 (1.50) | 5.25 (1.58) | 4.75 (1.43) | Surfactant |
| (30%), CAS# 151-21-3 | | | | | |
| Wintergreen Oil | 0.23 | 0.23 | 0.25 | 0.21 | Fragrance |
| (100%), CAS# 68917- | | | | | |
| 75-9 | | | | | |
| Thyme Oil (100%), | 0.19 | 0.19 | 0.21 | 0.17 | Fragrance |
| CAS# 8007-46-3 | | | | | |
| Cedarwood Oil Texas | 0.03 | 0.03 | 0.033 | 0.027 | Fragrance |
| (100%), CAS# 68990- | | | | | |
| 83-0 | | | | | |
| Purified water, | 72.00 | 72.00 | 74.16 | 69.84 | Solvent |
| CAS# 7732-18-5 | | | | | |
| | Total | Total | | | |
| | weight | percent | | | |
| | 100 lbs. | 100% | | | |

Column B and C shows a preferred formulation in terms of weight and weight percentages. Columns D and E define the upper and lower limits for the formulation, with the extension from the preferred formulation varying about 5% above and below the target amounts for citric acid, isopropanol, and sodium lauryl sulfate, varying about 10% above and below the target amounts for the wintergreen oil, thyme oil and cedarwood oil, and varying about 3% above and below for the target amount for water.

It is also believed that the formulation can be an effective, cleaner, disinfectant, and deodorizer when the target values of Column B vary by 10% for the citric acid, the isopropanol, and sodium lauryl sulfate. Thus, the citric acid range (50% active) would be about 3.78 to about 4.53%. The other ranges based on a 10% variance would be isopropanol: about 16.59 to about 20.27%, and the sodium lauryl sulfate: about 4.5 to about 5.5%. The water amount can also vary by 10% above or below the target amount such that the water would range between about 64.8 and about 79.2%.

The formulation is for the purpose of being a botanical EPA 25(b) antimicrobial cleaner/disinfectant. Put another way, all of the components of the formula are found in the listing of active and inert or inactive ingredients found in the publications from the Environmental Protection Agency entitled “Active Ingredients Eligible for Minimum Risk Pesticide Products (Updated December 2015)” and “Inert Ingredients Eligible for FIFRA 25(b) Pesticide Products (Revised November 2016).” The publications are publicly available and shown below as Tables 1 and 2.

The inventive formulation is unique in that it is considered to be a cleaner/disinfectant/bactericide, virucide, fungicide/mildicide/mold killer, that is effective and, at the same time, is made up of components that are all considered to be minimal risk components from the perspective of the EPA and FDA. Thus, the formulation combines not only the benefits of being based on minimal risk components but is also a formulation that is effective as a disinfectant (bactericide, virucide, mildicide), cleaner, and deodorizer.

The formulation has been shown to have superior disinfecting performance against bacteria, viruses, and fungus. More particularly, the formulation has been shown to have the following performances.

DISINFECTION PERFORMANCE: The inventive formulation kills the following bacteria in 10 minutes and 5% soil, on hard, non-porous surfaces:
Pseudomonas aeruginosa (ATCC 15442);
Salmonella enterica (ATCC 10708); and
Staphylococcus aureus (ATCC 6538).

VIRUCIDAL PERFORMANCE: The inventive formulation kills the following viruses in 5 minutes and 5% soil, on hard, non-porous surfaces:
Human Corona Virus (ATCCVR-740);
Norovirus (Norwalk-like Virus)(Feline Calicivirus))(VR-782); and
Polio Virus Type 1 (ATCC VR-1562).

VIRUCIDAL PERFORMANCE: The inventive formulation kills the following viruses in 90 seconds and 5% soil, on hard, non-porous surfaces:
SARS-Related Coronavirus 2 (SARS-CoV-2).

FUNGICIDAL PERFORMANCE: The inventive formulation kills the following viruses in 10 minutes and 5% soil, on hard, non-porous surfaces:
Trichophyton mentagrophytes (ATCC 9533) (athlete's foot) (a cause of Ringworm).

The EPA guidelines on disinfection state that a greater than or equal to 6-fold logarithmic (≥6 log) reduction in less than 10 minutes is needed to claim disinfection. The performance information provided above for the inventive formulation in terms of bacteria performance indicates that the formulation meets the EPA guidelines in terms of greater than or equal to 6 log reduction in less than 10 minutes. As is known in the art, a ≥6 log reduction means that 1 CFU is left and the percentage of reduction based on 1,000,000 CFU is 99.9999 percentage reduction. The performance information in terms of virucide and fungicide indicates a greater than or equal to 5 log reduction or 99.999 percentage reduction.

The following are examples of locations that can have surfaces that can be treated with the inventive formulation:
airline terminals, airports, bus stations, train stations, transportation terminals, public facilities, shipping terminals, travel rest areas, waysides;
automobiles, cars, trucks, campers, RVs, trailers, automotive garages, auto repair centers, bicycle shops;
boats, ships, barges, cruise lines, cruise ships, watercrafts;
boxcars, tankers, and tank trucks;
buses, public transportation, trains, taxis, airplanes, helicopters;
delivery trucks, garbage trucks, maintenance vehicles;
EMS and fire facilities, emergency vehicles, ambulances, police cars, fire trucks;
police stations, crime scenes, courthouses, correctional facilities, municipal government buildings, prisons, jails, penitentiaries, correctional institutions;
recycling centers;
athletic facilities, locker rooms, exercise rooms, exercise facilities, gyms, gymnasiums, field houses;
banks, churches, libraries, post offices;
campgrounds, playgrounds, recreational facilities, picnic facilities;
day care centers, nurseries, kindergartens, and preschools;
funeral homes, morgues, mortuaries, burial vaults, mausoleums, cadaver processing areas
hotels, motels;
museums, art galleries, performance/theater centers, movie houses, bowling alleys;
restaurants, bars, kitchens, taverns, cafeterias, institutional kitchens, fast food operations, food storage areas, catering, bakeries;
schools, colleges, dormitories, classrooms, community colleges, universities;
sports arenas, sports complexes;
supermarkets, convenience stores, retail and wholesale establishments, department stores, shopping malls, gift shops, video stores, bookstores, dressing rooms, photocopy centers;
veterinary, veterinary clinics, animal life science laboratories, animal laboratories, animal research centers, animal quarantine areas, animal holding areas, equine farms, dog, cat, and animal kennels, animal breeding facilities, breeding establishments, animal husbandry establishments, grooming establishments, pet animal quarters, animal housing facilities, zoos, tack shops, pet shops, operating rooms, washing areas, waiting rooms, examination rooms and other animal care facilities;
businesses, office buildings, workstations, break rooms, public restrooms, housekeeping, janitorial rooms;
commercial recirculating cooling water towers but not for use in cooling towers, water cooling systems in CA;
cosmetic manufacturing facilities, medical device manufacturing facilities, biotechnology firms, pharmaceutical manufacturing facilities;
factories, computer manufacturing sites, toy factories, warehouses;
institutional, commercial, industrial, institutions, commercial sites, industrial sites, institutional facilities, public places;
laboratories;
basements, cellars, bedrooms, attics, garages, living rooms, and porches;
bathrooms, restrooms, shower rooms, shower and bath areas;
kitchens and bathrooms and other household areas;
breweries, canneries, cheese factories;
bottle washing premises;
dairy, equine, poultry/turkey farms;
farmhouses, barns, sheds, tool sheds, animal barns, e.g., for cattle, swine, sheep, and horses, pens and stalls, swine quarters, livestock farms, equine quarters, brooder houses, seed houses and veal, calving, hog, cattle and horse operations, chick vans, egg trucks, hatchery and farm vehicles;
federally inspected meat and poultry plants;
food establishments, coffee shops, donut shops, bagel stores, pizza parlors, liquor stores, wineries;
food handling and processing areas;
food processing plants, USDA inspected food-processing facilities, federally inspected meat and poultry plants, egg processing plants, poultry and turkey farms, farms, dairy farms, hog farms, meat/poultry processing plants, rendering plants, poultry and animal dressing plants, canneries, meat packing plants, hide and leather processing plants;
poultry premises like hatcheries, egg receiving area; egg holding area; setter room; tray dumping area; chick holding area; hatchery room; chick processing area; chick loading area;
poultry buildings;
processing facilities for fish, milk, citrus, wine, fruit, vegetable, ice cream and potato and beverage plants;
swine premises: farrowing barns and areas dressing plants blocks waterers and feeders loading equipment creep area hauling equipment nursery chutes area;
tobacco plant premises;
hospitals, nursing homes, medical and dental offices and clinics, healthcare facilities, physician offices, operating rooms/theaters, radiology rooms, isolation wards, quarantine areas, hospices, medical research facilities, washing areas, cu areas, autopsy rooms, acute care institutions, alternate care institutions, home healthcare institutions, sick rooms;
life care retirement communities, elder care centers, elder care facilities; and
patient care rooms & facilities, recovery rooms, emergency rooms, x-ray cat labs, exam rooms, newborn nurseries, neonatal units, orthopedics, respiratory therapy, surgical centers, out-patient surgical centers, labs, blood collection rooms, central supply, housekeeping & janitorial rooms, ophthalmic/optometric facilities.

Examples of surfaces, preferably those at room temperature, that can be treated with the inventive formulation include the following:
countertops, counters, countertop laminates, stovetops and stoves, bathroom and kitchen sinks, tub surfaces, shelves, racks, carts, appliances, refrigerators, ice machines, microwave ovens;
dishes, glassware, glasses, silverware, cooking utensils, eating utensils, plastic and other hard, non-porous cutting boards, plastic and other hard, non-porous chopping blocks, coolers, ice chests, refrigerator bins used for meat, vegetables, fruit and eggs, Tupperware™;
sealed floors, finished floors, sealed or finished high speed burnished floors, sealed or finished conductive flooring, walls, ceilings, fixtures;
glass surfaces, aluminum, laminated surfaces, metal, plated steel, stainless steel, glazed porcelain, glazed file, glazed ceramic, sealed granite, sealed marble, plastic, such as polycarbonate, polyvinylchloride, polystyrene or polypropylene, sealed limestone, sealed slate, sealed stone, sealed terra cotta, sealed terrazzo, chrome, Plexiglas™, enameled surfaces, painted or finished woodwork, Formica, vinyl and plastic upholstery, washable wallpaper, windows, mirrors, painted surfaces;
highchairs, baby cribs, diaper changing stations, infant bassinets/cribs/warmers/incubators/care equipment, folding tables, hampers, laundry pails, empty diaper pails;
shower stalls, shower doors and curtains, bathtubs and glazed tiles, chrome plated intakes, vanity tops, and restroom fixtures, bathroom fixtures, bathroom bowls, basins, tubs;
tables, chairs, desks, folding tables, bed frames, lifts, washable walls, cabinets, doorknobs and garbage cans/pails, trash barrels, trash cans, trash containers, industrial waste receptacles and garbage handling equipment, shelves, racks and carts, door knobs and handles;
sealed foundations, steps, plumbing fixtures, finished baseboards and windowsills;
other hard, non-porous surfaces;
automobile interiors, mats, crates, cabs, and wheels;
commercial florist pots, flats and flower buckets, work areas and benches;
crypton barrier fabric;
hard hats, headphones;
hard, non-porous surfaces of picnic tables and outdoor furniture;
kennel runs, cages, sealed kennel/cage floors, sealed conductive flooring, examination tables, veterinary x-ray tables, loading platforms, animal equipment;
large inflatable, non-porous plastic and rubber structures such as animals, promotional items, moonwalks, slides, obstacle course, play and exercise equipment;
maintenance equipment;
non-wooden picnic tables and outdoor furniture except cushions and wood frames;
playground equipment;
Slurpee™ machines, drinking fountains;
telephones and telephone booths;
wrestling and gymnastic mats, athletic mats, athletic training tables, physical therapy tables, exercise equipment, athletic helmets, wrestling/boxing headgear, athletic shoe soles, and locker rooms/areas;
beer fermentation and holding tanks, bottling or pre-mix dispensing equipment;
citrus processing equipment and holding tanks;
equipment, pipelines, tanks, vats, filters, evaporators, pasteurizers, and aseptic equipment in dairies, breweries, wineries, beverage and food processing/packing plants, and egg processing/packing equipment surfaces;
hard, non-porous surfaces in food preparation and storage areas;
hatchers, setters, trays, racks, egg flats, chick boxes, egg cases, vans and trash containers, seed houses, poultry/turkey equipment, carts, sexing tables, and automated tray, rack and buggy washers, egg receiving and egg holding areas;
harvesting & handling equipment;
ice machines;
kitchen equipment such as food processors, blenders, cutlery, trash compactors and other utensils;
meat packing plant surfaces such as livestock vehicles and holding pens, receiving areas and delivery chutes, slaughter areas and conveyors, hand, rub and guide rails, post knock cabinets, stands and sealed flooring surfaces, chains and moving process lines, chutes, conveyors, tallow and animal feed production surfaces, processed product and offal equipment surfaces, fabrication and processing areas covering cold storage areas, stainless steel cut out and prep tables, and other stainless surfaces tobacco plant equipment;
wine processing equipment and holding tanks;
external lenses, vision correction devices including eyeglasses, protective eyewear, goggles, light lens covers, optical instruments/implements;
hospital beds, bed railings, bedpans, gurneys, traction devices, MRI, cat, examining tables, scales, paddles, wheelchairs;
hard, non-porous surfaces of cervical collars and neck braces, spine backboards, stretchers, unit stools, CPR training mannequins, curing lights, light lens covers, slit lamps, operating room lights, operating tables, oxygen hoods, dental chairs/countertops, examination tables, x-ray tables, ambulance equipment/surfaces, medical equipment surfaces. exhaust fans, refrigerated storage and display equipment, coils and drain pans of air conditioning, refrigeration equipment;
heat pumps;
interior hard, non-porous surfaces of water softeners, reverse osmosis units, ice machines, water coolers, water holding tanks; and
pressure tanks.

The inventive formulation can be used to disinfect air ducts as it controls bacteria on air duct surfaces.

The inventive formulation can be used to disinfect, clean, and deodorize terrarium and small animal cages, substrate and other hard, non-porous cage equipment, furniture, plastic terrarium ornaments, heat caves, and water dishes, but the formulation is not suitable for porous rocks, hot rocks, or driftwood.

The inventive formulation is especially adapted for toilet bowl and urinal disinfecting and cleaning, disinfecting tubs, shower stalls, sinks, and faucets, and cleaning and disinfecting shower rooms, locker rooms and other large open areas, particularly those with floor drains.

Again, the inventive formulation controls 99.9999% of bacteria on hard non-porous surfaces and controls 99.99% of viruses on hard non-porous surfaces.

In terms of killing virus and bacteria on surfaces, the inventive formulation provides the following capabilities:
kills the virus that causes covid-19;
kills polio virus on hard-nonporous surfaces;
kills norovirus on hard non-porous surfaces;
kills Salmonella on hard-nonporous surfaces;
is formulated with 100% EPA listed minimum risk ingredients;
can be used to disinfectant food contact surfaces without needing a final rinse;
cleans and disinfects non-medical (i.e., industrial and firefighting) hard, non-porous respirators in industrial, commercial. and institutional premises;
cleans and disinfects hard, non-porous surfaces without dulling gloss;
cleans, disinfects, and deodorizes on hard, non-porous surfaces;
cleans, disinfects. and deodorizes hard, non-porous surfaces by killing many odor-causing microorganisms;
cleans, disinfects, and eliminates odors leaving hard, non-porous surfaces smelling clean and fresh;
cleans, disinfects, and deodorizes hard, non-porous surfaces by killing odor-causing microorganisms;
cleans, disinfects, and deodorizes hard, non-porous hospital and medical-related surfaces in one step (with no rinsing required);
cleans, disinfects, and deodorizes hard, non-porous surfaces such as flower buckets, walls, sealed floors of coolers, shippers, greenhouse packing areas, garbage pails, design and packing benches, and countertops, and other areas where obnoxious odors develop;
cleans and disinfects hard, non-porous surfaces of personal protective safety equipment, protective headgear, athletic helmets, wrestling/boxing headgear, athletic shoe soles, hard hats, headphones, half mask respirators, full face breathing apparatus, gas masks, goggles, spectacles, face shields, hearing protectors and ear muffs. rinse all equipment that comes in prolonged contact with skin before reuse with clean warm water (about 120° F.), and allow to air dry. (precaution: cleaning at 120° F. temperature will avoid overheating and distortion of the personal safety equipment that would necessitate replacement);
cleans and disinfects hard, non-porous ambulance equipment and surfaces;
cleans, shines, deodorizes, and disinfects all hard, non-porous surfaces;
disinfects;
disinfects hard, non-porous athletic surfaces;
disinfects kitchen and bathroom surfaces and sealed floors;
economical concentrated disinfectant designed for daily cleaning and easy on surfaces;
effective one-step disinfectant-cleaner for use in hospitals, e.g., ambulatory care centers, long term care facilities, and other healthcare settings when the used directions or disinfection directions are followed;
has been formulated to aid in the reduction of cross-contamination on hard, non-porous treated surfaces not only in hospitals, but also in schools, institutions, and industry;
helps reduce cross-contamination on hard, non-porous treated surfaces;
is a bowl and/or bathroom cleaner, which cleans, disinfects, and deodorizes;
is a cleaner and deodorant/odor-counteractant/odor-neutralizer designed for general cleaning and disinfecting/deodorizing on hard, non-porous surfaces;
is a cleaner designed for general cleaning and disinfecting/deodorizing on hard, non-porous surfaces;
is a concentrated hospital use disinfectant that is effective against a broad spectrum of bacteria, is virucidal, and eliminates odor-causing bacteria when used as directed;
is a disinfectant for cleanroom and laboratory areas to disinfect washable, hard, non-porous, non-food contact surfaces such as: laminar-airflow equipment and biosafety cabinet work surfaces and exterior surfaces of the following: countertops, sinks, plumbing fixture surfaces, and incubator, refrigerators and centrifuge surfaces of metal, stainless steel, glass, plastic such as polystyrene or polypropylene, Formica™, and vinyl;
is a disinfectant cleaner that cleans, disinfects, and deodorizes in one labor saving step.
is a multi-surface cleaner, deodorizer, and disinfectant;
is a hospital-use germicidal/disinfectant cleaner and deodorant, i.e., odor-counteractant and/or odor neutralizer, designed for general cleaning, disinfecting, and deodorizing of hard, non-porous surfaces;
is a one-step disinfectant that is effective against a broad spectrum of bacteria, is virucidal, including HIV-1, HCV, and HBV, and inhibits their odors when the use directions or disinfection directions are followed;
is a proven disinfectant, cleaner, and virucide;
is a versatile disinfectant for veterinarian, veterinary practice, animal care, animal laboratory, and agricultural and farm premise applications;
is an effective bactericide and virucide disinfectant in the presence of organic soil (5% blood serum);
is designed to provide both general cleaning and disinfection, including for larger areas such as operating rooms and patient care;
is for use in federally inspected meat and poultry plants on all hard, non-porous surfaces in inedible product processing areas, non-processing areas and/or exterior areas, federally inspected meat and poultry plants as a sealed floor and wall cleaner for use in all departments, and federally inspected meat and poultry plants as a disinfectant agent for use in all departments.
kills bacteria and helps reduce cross-contamination on treated hard, non-porous non-food contact kitchen surfaces listed on a label on the container of the formulation;
kills common kitchen and bathroom germs, bacteria, and viruses;
kills, removes, and destroys germs, bacteria and viruses on hard, non-porous surfaces;
may be used to clean and disinfect finished floors;
may be used to clean and disinfect sealed floor areas, sinks, faucets, bathrooms, and tubs;
multi surface cleaner disinfectant;
one-step disinfectant cleaner, when the use directions or disinfection directions are followed; and
proven one-step disinfectant virucide, which is effective in water up to 400 ppm hardness in the presence of 5% serum contamination, when the use directions or disinfection directions are followed;
Other features and/or characteristics of the inventive formulation are as follows:
can be applied through foaming apparatus, and low-pressure sprayer systems when following manufacturers' instructions when using this equipment;
can be formulated as a clear formula due to is microemulsion nature;
is a clear drying formula;
cuts cleaning time;
is designed for daily use on common materials found in hospitals;
is designed for healthcare non-critical hard, non-porous surfaces;
evaporates completely;
is formulated for effective poultry sanitation;
is formulated for effective swine premise sanitation;
good for use with microfiber cloths;
has been designed specifically where housekeeping is of prime importance;
is an economical concentrate that can be diluted for use with a mop and bucket, cloth microfiber cloth, sponge, coarse spray device or by soaking;
is for use on sealed floors, walls, file, cages, crates, mats, litter boxes, floor coverings, or any hard, non-porous surfaces soiled by a pet;
is for larger areas such as operating rooms and patient care facilities;
leaves no visible residue;
makes cleaning easier,
may cause bleaching of treated surfaces, test commodity if unsure;
no harsh alcohol smell;
no harsh bleach smell;
non-abrasive formula will not harm or scratch surfaces;
non-dulling formula eliminates the time and labor normally required for rinsing;
use this product to treat hard, non-porous multi-touch surfaces responsible for cross-contamination;
will control unpleasant malodors and odors;
will not harm sealed stone, sealed grout, or glazed tile;
will not harm most surfaces; and
will not leave a grit or soap scum.

Besides the disinfecting properties of the inventive formulation, the formulation can also act as a cleaner, deodorizer and degreaser as detailed below:
eliminates odors leaving surfaces smelling clean and fresh;
removes/eliminates odors caused by bacteria and non-fresh foods leaving restrooms and kitchen surfaces smelling clean and fresh;
can be used for daily cleaning; can be used as a degreaser
can be used where odors are a problem;
cleans and shines by removing dirt, grime, and food soils in food preparation and processing areas, everyday kitchen messes, non-food contact kitchen surfaces and food preparation areas, like dirt, grease, and food stains;
cleans and degreases quickly by removing dirt, grime, food residue, body oils, dead skin, blood and other commonly found organic matter;
cleans and degreases by removing dirt, grime, blood, urine, fecal matter and other common soils found in animal housing facilities, livestock, swine or poultry facilities, grooming facilities, farms, kennels, pet stores, veterinary clinics, laboratories or other small animal facilities;
cleans rodent soiled areas;
controls, reduces, eliminates, neutralizes, destroys odors to make your home, kitchen, bathroom sanitary;
cuts through tough grease and grime;
deodorizes by killing microorganisms that cause offensive odors;
deodorizes hard, non-porous surfaces in restroom areas, behind and under sinks and counters, garbage cans and garbage storage areas, and other places where bacterial growth can cause malodors;
deodorizes hard, non-porous surfaces by killing microorganisms that cause offensive odors;
is a sealed floor cleaner;
is for use in work areas such as tool rooms and garages for odor control and light duty cleaning;
is for non-scratch cleaning of showers and tubs, shower doors and shower curtains;
is formulated to provide effective cleaning strength that will not dull high gloss floor finishes with repeated use;
kills odor-causing bacteria, particularly that found in kitchens and bathrooms;
has malodor activity by counteracting or eliminating or destroying odors and odor-causing bacteria on hard, non-porous surfaces in restroom areas, behind and under sinks and counters, and storage areas (and other hard, non-porous surfaces) where bacterial growth can cause malodors;
maximizes and improves labor results by effectively controlling odors;
neutralizes musty odors and tough odors from smoke, pet accidents, and spills on contact;
provides long lasting freshness against tough odors such as odors from litter boxes and pet accidents;
provides effective cleaning strength that will not dull most metal-interlock floor finishes, and does not require a rinse prior to recoat;
removes dirt;
removes stains;
removes and/or cleans stains and soils like bathtub rings, dirt, laboratory stains, other common soils and/or stains, blood, fecal matter, other organic matter, body oils, grime, and urine.

The inventive formulation is advantageous in that it is easy to use, does not require the use of a separate deodorizer, and the bottle or container for the formulation can be made of post-consumer recycled plastic.

Other advantages include the fact that the formulation is considered effective against any emerging viral pathogen such as an enveloped virus like the polio virus, a large non-enveloped virus like the polio virus, and small non-enveloped virus like Polio Virus (ATCC VR-1562) and Feline Calicivirus (ATCC VR0782) (surrogate for Norovirus).

The formulation is also considered a 6 log disinfectant for bacteria and one that contains cedarwood oil and can be diluted for cleaning purposes, if so desired. The inventive formulation qualifies as a minimal risk disinfectant for both the EPA and the FDA.

In terms of using the formulation, it can be used in a similar fashion as other cleaners and disinfectants are used. In certain situations, the need for cleaning and/or disinfecting may require a pre-cleaning of the area in need of treatment. When treating a particular area, the formulation solution can be applied to visibly soiled areas to disinfect hard, non-porous surfaces with a sponge, brush, cloth, mop, by immersion, using an auto scrubber, mechanical spray device, hand pump, or coarse trigger spray device. For spray applications, spraying 6-8 inches from surface is preferred. In certain medical application, the treated surfaces should must remain visibly wet for the appropriate time as designated by the medical rules that apply for the particular cleaning/disinfecting being done. The area can be wiped dry with a clean cloth or allowed to air dry. Generally, rinsing of floors is not necessary unless they are to be waxed or polished. Use a fresh solution should be used daily or when the formulation is visibly dirty.

While the formulation can be used at full strength, it can also be diluted depending on a given cleaning/disinfecting application. For example, when treating canine parvovirus, four (4) ounces of the formulation can be diluted in a gallon of water. To use as a general cleaner, two (2) fluid ounces could be used per gallon of water. For use as a general cleaner and/or deodorizer and/or degreaser, one can use a solution of 2 fl. oz. of the formulation per gal. of water (or equivalent use dilution) to hard, non-porous surfaces. One can optionally rinse, wipe up excess liquid, e.g., with a paper towel and/or allow to air dry. For heavy-duty use, one can use 4 fl. oz. of the formulation per gal. of water to clean hard, non-porous surfaces. To clean/remove soap scum, one can apply a solution of 2 fl. oz. of the formulation per gal. of water onto soils and wipe clean with a dry paper towel or lint-free cloth or microfiber cloth or sponge. No rinsing is necessary. For best results, a dry paper towel or lint-free cloth or a microfiber cloth or sponge can be used for wiping purposes. One can repeat the procedure for visibly soiled areas. for stubborn stains or visibly soiled areas or tougher jobs, allow the formulation to penetrate dirt and/or soap scum before wiping. For best results, use regularly to prevent dirt and soap scum build-up.

For general deodorization, one can apply a solution of 2 fl. oz. of the formulation per gal. of water (or equivalent use dilution) to hard, non-porous surfaces. Once application, one can rinse/wipe up excess liquid with a paper towel and/or allow to air dry.

For glass cleaning and deodorizing, one can use a solution of 2 fl. oz. of the formulation per gal. of water and use the made solution to clean and deodorize windows, mirrors, and glass surfaces. A coarse spray device can be used wherein one can spray 6-8 inches from surface.

Preferably the spray should not be inhaled. The surface can be rubbed with sponge or cloth and the cloth, sponge or towels should be changed frequently to avoid re-deposition of soil. As a general degreaser, one can apply 2 fl. oz. of the formulation per gal. of water (or equivalent use dilution) to hard, non-porous surfaces. Once applied, a rinse or excess liquid wipe up with a paper towel can be practiced or the surface can be allowed to air dry.

While not necessary, it is also advantageous to provide the formulation as a microemulsion as it says in solution and does not require constant or intermittent mixing or shaking.

Microemulsions are known as a clear, thermodynamically stable, isotropic liquid mixtures of oil, water and one or more surfactants. The aqueous phase may contain salt(s) and/or other ingredients, and the oil may actually be a complex mixture of different hydrocarbons and olefins. Microemulsions are contrasted with emulsions in that microemulsions form upon simple mixing of the components and do not require high shear conditions generally used in the formation of ordinary emulsions. The three basic types of microemulsions are direct (oil dispersed in water, o/w), reversed (water dispersed in oil, w/o) and bicontinuous.

In ternary systems such as microemulsions, where two immiscible phases (water and oil) are present with a surfactant, the surfactant molecules may form a monolayer at the interface between the oil and water, with the hydrophobic tails of the surfactant molecules dissolved in the oil phase and the hydrophilic head groups in the aqueous phase.

Second, as the formulation only uses 25(b) components, it is an all-natural product. Other disinfecting/cleaning products have non-25(b) components, e.g., copper sulfate, or the thyme is not naturally based (it is derived from a petroleum product), and these kinds of products cannot be characterized as a 25(b) formulation.

While the sodium lauryl sulfate (SLS) is disclosed as a preferred surfactant for use in the microemulsion, other surfactants similar to SLS can be used that satisfy the 25(b) criteria of the Environmental Protection Agency, as found in Tables 1 and 2.

Citric acid is an ingredient in terms of the formulation as shown in Table A. The form of the citric acid can be any kind, e.g., provided as citric acid anhydrous fine granules, which are readily available commercially. The granules are dissolved in warm water when making the microemulsion.

The purpose of the isopropanol is for microemulsification.

The pH of the formulation should be adjusted to between 6.0 and 8.0. The pH is controlled by the addition of the citric acid. Citric acid is a weak organic acid that has the chemical formula C₆H₈O₇. It occurs naturally in citrus fruits. In biochemistry, it is an intermediate in the citric acid cycle, which occurs in the metabolism of all aerobic organisms.

The thyme oil or Thymus vulgaris make up is found in the Bond patent noted above so that a further description of it is not necessary for understanding of the invention.

All components are preferably food grade quality. The wintergreen, thyme, and cedarwood oils are all natural oils that are readily available for use in the formulation.

In applying the formulation, including one as a microemulsion, for cleaning purposes, any kind of an application can be used. Examples include spraying, brushing, foaming, wiping using rags, paper towels, and the like. Different kinds of applications could be combined as well. In fact, the formulation can be applied in virtually any way for cleaning and disinfecting a desired surface, whether the surface is large or small.

The formulation can be used as described above or diluted as described above. The dilutions of 2 and 4 ounces per gallon of water are only exemplary and other dilutions could be used, 1 ounce or 16 ounces for example.

As noted above, a significant advantage of the invention is being able to provide a cleaning, disinfecting, and deodorizing product that falls under the EPA's minimum risk pesticide guidelines and is exempt from required registration under the Federal Insecticide, Fungicide, and Rodenticide Act, the exemption found in 40 CFR 152.25(f), which is incorporated by reference in its entirety. Other advantages include the ability to provide a formulation that is crystal clear for application and have disinfectant and anti-microbial/anti-fungal properties.

What is remarkable about the formulation is that it is a first of its kind in terms of a microemulsion that is completely compliant with FIFRA 25(b) as every ingredient in it falls under 25(b); there are no metals and no synthetic thyme products. As importantly, the formulation is shown to have surprising disinfectant properties as a bactericide, virucide, and mildicide.

Extensive testing has been performed in connection with the bacteria, virus, and fungi to demonstrate the efficacy of the formulation, such testing in compliance with EPA requirements for formulation registration purposes. Testing was also conducted in terms of acute eye irritation. skin sensitization, acute oral toxicity, acute dermal toxicity-acute skin irritation, and accelerated storage stability-corrosion characteristics and all of the standards associated with this testing was deemed to be met such that the formulation could be used in the applications and methods as described above for disinfection, deodorizing, and cleaning. Since the component parts of the formulation are all 25(b) components, the EPA, in certain instances, does not require registration. However, the formulation of the invention is still registered under a different registration standard, i.e., disinfection pesticide, such registration also permitting registration in foreign countries.

As such, an invention has been disclosed in terms of preferred embodiments thereof which fulfills each and every one of the objects of the present invention as set forth above and provides a new and improved formulation that can be used for disinfection and/or cleaning of surfaces.

Of course, various changes, modifications and alterations from the teachings of the present invention may be contemplated by those skilled in the art without departing from the intended spirit and scope thereof. It is intended that the present invention only be limited by the terms of the appended claims.

TABLE 1
Active Ingredients Eligible for Minimum Risk Pesticide Products
(Updated December 2015)

| Label Display | | | | Nonfood | Food |
|---|---|---|---|---|---|
| Name | Chemical Name | CAS No. | Specifications | Use | Use |
| Castor oil | Castor oil | 8001-79-4 | United States | ✓ | ✓ |
| | | | Pharmacopeia | | |
| | | | (U.S.P.) or | | |
| | | | equivalent | | |
| Cedarwood oil | Cedarwood oil (China) | 85085-29-6 | — | ✓ | |
| Cedarwood oil | Cedarwood oil (Texas) | 68990-83-0 | — | ✓ | |
| Cedarwood oil | Cedarwood oil (Virginia) | 8000-27-9 | — | ✓ | |
| Cinnamon | Cinnamon | N/A | — | ✓ | ✓ |
| Cinnamon oil | Cinnamon oil | 8015-91-6 | — | ✓ | ✓ |
| Citric acid | 2-Hydroxypropane-1,2,3- | 77-92-9 | — | ✓ | ✓ |
| | tricarboxylic acid | | | | |
| Citronella | Citronella | N/A | — | ✓ | |
| Citronella oil | Citronella oil | 8000-29-1 | — | ✓ | |
| Cloves | Cloves | N/A | — | ✓ | ✓ |
| Clove oil | Clove oil | 8000-34-8 | — | ✓ | ✓ |
| Corn gluten meal | Corn gluten meal | 66071-96-3 | — | ✓ | ✓ |
| Corn oil | Corn oil | 8001-30-7 | — | ✓ | ✓ |
| Cornmint | Cornmint | N/A | — | ✓ | ✓ |
| Cornmint oil | Cornmint oil | 68917-18-0 | — | ✓ | ✓ |
| Cottonseed oil | Cottonseed oil | 8001-29-4 | — | ✓ | ✓ |
| Dried blood | Dried blood | 68911-49-9 | — | ✓ | |
| Eugenol | 4-Allyl-2-methoxyphenol | 97-53-0 | — | ✓ | |
| Garlic | Garlic | N/A | — | ✓ | ✓ |
| Garlic oil | Garlic oil | 8000-78-0 | — | ✓ | ✓ |
| Geraniol | (2B)-3,7-Dimethylocta-2,6- | 106-24-1 | — | ✓ | ✓ |
| | dien-1-ol | | | | |
| Geranium oil | Geranium oil | 8000-46-2 | — | ✓ | |
| Lauryl sulfate | Lauryl sulfate | 151-41-7 | — | ✓ | ✓ |
| Lemongrass oil | Lemongrass oil | 8007-02-1 | — | ✓ | |
| Linseed oil | Linseed oil | 8001-26-1 | — | ✓ | ✓ |
| Malic acid | 2-Hydroxybutanedioic acid | 6915-15-7 | — | ✓ | |
| Peppermint | Peppermint | N/A | — | ✓ | ✓ |
| Peppermint oil | Peppermint oil | 8006-90-4 | — | ✓ | ✓ |
| 2-Phenylethyl propionate | 2-Phenylethyl propionate | 122-70-3 | — | ✓ | |
| Potassium | Potassium (2E,4E)-hexa-2,4- | 24634-61-5 | — | ✓ | ✓ |
| sorbate | dienoate | | | | |
| Putrescent whole egg solids | Putrescent whole egg solids | 51609-52-0 | — | ✓ | ✓ |
| Rosemary | Rosemary | N/A | — | ✓ | ✓ |
| Rosemary oil | Rosemary oil | 8000-25-7 | — | ✓ | ✓ |
| Sesame | Sesame | N/A | Includes ground | ✓ | ✓ |
| | | | sesame plant | | |
| Sesame oil | Sesame oil | 8008-74-0 | — | ✓ | ✓ |
| Sodium chloride | Sodium chloride | 7647-14-5 | — | ✓ | ✓ |
| Sodium lauryl | Sulfuric acid monododecyl | 151-21-3 | — | ✓ | ✓ |
| sulfate | ester, sodium salt | | | | |
| Soybean oil | Soybean oil | 8001-22-7 | — | ✓ | ✓ |
| Spearmint | Spearmint | N/A | — | ✓ | ✓ |
| Spearmint oil | Spearmint oil | 8008-79-5 | — | ✓ | ✓ |
| Thyme | Thyme | N/A | — | ✓ | ✓ |
| Thyme oil | Thyme oil | 8007-46-3 | — | ✓ | ✓ |
| White pepper | White pepper | N/A | — | ✓ | ✓ |
| Zinc | Zinc | 7440-66-6 | Zinc metal | ✓ | |
| | | | strips | | |
| | | | (consisting | | |
| | | | solely of zinc | | |
| | | | metal and | | |
| | | | impurities) | | |

| If the tolerance exemption | Then the inert ingredient may be included in a minimum risk product that |
|---|---|
| appears in . . . | is applied to: |
| 40 CFR180.910 | Growing crops or raw agricultural commodities after harvest. |
| 40 CFR 180.920 | Growing crops |
| 40 CFR 180.930 | Animals |
| 40 CFR 180.940(a) | Food-contact surfaces in public eating places, dairy-processing equipment, and |
| | food-processing equipment and utensils |
| 40 CFR 180.940(b) | Dairy-processing equipment, and food-processing equipment and utensils |
| 40 CFR 180.940(c) | Food-processing equipment and utensils |
| 40 CFR 180.950 | Any food-use site |
| 40 CFR 180.960 | Any food-use site |
| 40 CFR 180.1071 | One of the 14 specified use patterns appropriate for peanuts, tree nuts, milk, |
| | soybeans, eggs, fish, crustacea, and wheat . . . |
| 40 CFR 180.1087 | Residues of the biorational nematicide sesame stalk in or on the raw agricultural |
| | commodities identified in the tolerance exemption. |
| 40 CFR 180.1233 | Potassium sorbate exemption from the requirement of a tolerance |
| 40 CFR 180.1251 | Geraniol exemption from the requirement of a tolerance |

TABLE 2
Inert Ingredients Eligible for FIFRA 25(b) Pesticide Products
(Revised November 2016)

| | | | | | Tolerance |
|---|---|---|---|---|---|
| | | | | | Exemption |
| Label Display | | | Nonfood | Food | Citation 40 |
| Name | Chemical Name | CAS No. | Use | Use | 180.xxx^{/1,2} |
| Acetyl tributyl citrate | Citric acid, 2-(acetyloxy)-, | 77-90-7 | ✓ | ✓ | 950(e) |
| | tributyl ester | | | | |
| Agar | Agar | 9002-18-0 | ✓ | | |
| Almond hulls | Almond hulls | N/A | ✓ | ✓ | 950(b) |
| Almond oil | Oils, almond | 8007-69-0 | ✓ | | |
| Almond shells | Almond shells | N/A | ✓ | ✓ | 950(b) |
| alpha-Cyclodextrin | alpha-Cyclodextrin | 10016-20-3 | ✓ | ✓ | 950(e) |
| Aluminatesilicate | Aluminatesilicate | 1327-36-2 | ✓ | | |
| Aluminum magnesium | Silicic acid, aluminum | 1327-43-1 | ✓ | | |
| silicate | magnesium salt | | | | |
| Aluminum potassium | Silicic acid, aluminum | 12736-96-8 | ✓ | | |
| sodium silicate | potassium | | | | |
| Aluminum silicate | Aluminum silicate | 1335-30-4 | ✓ | | |
| Aluminum sodium | Silicic acid, aluminum sodium | 1344-00-9 | ✓ | ✓ | 910 |
| silicate | salt | | | | |
| Aluminum sodium | Silicic acid (H4 SiO4), | 12003-51-9 | ✓ | | |
| silicate | aluminum sodium salt (1:1:1) | | | | |
| Ammonium benzoate | Benzoic acid, ammonium salt | 1863-63-4 | ✓ | | |
| Ammonium stearate | Octadecanoic acid, ammonium | 1002-89-7 | ✓ | ✓ | 910 |
| | salt | | | | |
| Amylopectin, acid-hydrolyzed, | Amylopectin, acid-hydrolyzed, | 113894-85-2 | ✓ | ✓ | 950(e) |
| 1-octenylbutanedioate | 1-octenylbutanedioate | | | | |
| Amylopectin, hydrogen | Amylopectin, hydrogen 1- | 125109-81-1 | ✓ | ✓ | 1950(e) |
| 1-octadecenylbutanedioate | octadecenylbutanedioate | | | | |
| Animal glue | Animal glue | N/A | ✓ | ✓ | 950(e) |
| Ascorbyl palmitate | Ascorbyl palmitate | 137-66-6 | ✓ | ✓ | 910, 930 |
| Attapulgite-type clay | Attapulgite-type clay | 12174-11-7 | ✓ | ✓ | 910, 930 |
| Beeswax | Beeswax | 8012-89-3 | ✓ | ✓ | 950(e) |
| Bentonite | Bentonite | 1302-78-9 | ✓ | ✓ | 910 |
| Bentonite, sodian | Bentonite, sodian | 85049-30-5 | ✓ | | |
| beta-Cyclodextrin | beta-Cyclodextrin | 7585-39-9 | ✓ | ✓ | 950(e) |
| Bone meal | Bone meal | 68409-75-6 | ✓ | | |
| Bran | Bran | N/A | ✓ | ✓ | 1071 |
| Bread crumbs | Bread crumbs | N/A | ✓ | ✓ | 1071 |
| (+)-Butyl lactate | Lactic acid, n-butyl ester, (S) | 34451-19-9 | ✓ | ✓ | 950(e) |
| Butyl lactate | Lactic acid, n-butyl ester | 138-22-7 | ✓ | ✓ | 950(e) |
| Butyl stearate | Octadecanoic acid, butyl ester | 123-95-5 | ✓ | ✓ | 950(e) |
| Calcareous shale | Calcareous shale | N/A | ✓ | ✓ | 910 |
| Calcite | Calcite (Ca(CO₃)) | 13397-26-7 | ✓ | ✓ | 910, 930 |
| Calcium acetate | Calcium acetate | 62-54-4 | ✓ | | |
| Calcium acetate monohydrate | Acetic acid, calcium salt, | 5743-26-0 | ✓ | | |
| | monohydrate | | | | |
| Calcium benzoate | Benzoic acid, calcium salt | 2090-05-3 | ✓ | | |
| Calcium carbonate | Calcium carbonate | 471-34-1 | ✓ | ✓ | 910, 930 |
| Calcium citrate | Citric acid, calcium selt | 7693-13-2 | ✓ | ✓ | 950(e) |
| Calcium octanoate | Calcium octanoate | 6107-56-8 | ✓ | ✓ | 910 |
| Calcium oxide silicate | Calcium oxide silicate | 12168-85-3 | ✓ | | |
| | (Co₃ O(SiO₄)) | | | | |
| Calcium silicate | Silicic acid, calcium salt | 1344-95-2 | ✓ | ✓ | 910, 930 |
| Calcium stearate | Octadecanoic acid, calcium salt | 1592-23-0 | ✓ | ✓ | 910, 930, 940(a), |
| | | | | | 940(c) |
| Calcium sulfate | Calcium sulfate | 7778-18-9 | ✓ | | |
| Calcium sulfate dihydrate | Calcium sulfate dihydrate | 10101-41-4 | ✓ | | |
| Calcium sulfate hemihydrate | Calcium sulfate hemihydrate | 10034-76-1 | ✓ | | |
| Canary seed | Canary seed | N/A | ✓ | ✓ | 950(b) |
| Carbon | Carbon | 7440-44-0 | ✓ | | |
| Carbon dioxide | Carbon dioxide | 124-38-9 | ✓ | ✓ | 910, 930 |
| Carboxymethyl cellulose | Cellulose, carboxymethyl ether | 9000-11-7 | ✓ | | |
| Cardboard | Cardboard | N/A | ✓ | ✓ | 950(e) |
| Carnauba wax | Carnauba wax | 8015-86-9 | ✓ | ✓ | 950(e) |
| Carob gum | Locust bean gum | 9000-40-2 | ✓ | ✓ | 950(e) |
| Carrageenan | Carrageenan | 9000-07-1 | ✓ | ✓ | 910, 920, 930 |
| Caseins | Caseins | 9000-71-9 | ✓ | | |
| Castor oil | Castor oil | 8001-79-4 | ✓ | ✓ | 950(e) |
| Castor oil, hydrogenated | Castor oil, hydrogenated | 8001-78-3 | ✓ | ✓ | 950(e) |
| Cat food | Cat food | N/A | ✓ | | |
| Cellulose | Cellulose | 9004-34-6 | ✓ | ✓ | 950(e) |
| Cellulose acetate | Cellulose acetate | 9004-35-7 | ✓ | ✓ | 950(e) |
| Cellulose, mixture with | Cellulose, mixture with cellulose | 51395-75-6 | ✓ | ✓ | 950(e) |
| cellulose carboxymethyl | carboxymethyl ether, sodium salt | | | | |
| ether, sodium salt | | | | | |
| Cellulose, pulp | Cellulose, pulp | 65996-61-4 | ✓ | ✓ | 950(e) |
| Cellulose, regenerated | Cellulose, regenerated | 68442-85-3 | ✓ | ✓ | 950(e) |
| Cheese | Cheese | N/A | ✓ | ✓ | 950(a) or 1071 |
| Chlorophyll a | Chlorophyll a | 479-61-8 | ✓ | | |
| Chlorophyll b | Chlorophyll b | 519-62-0 | ✓ | | |
| Citric acid | Citric acid | 77-92-9 | ✓ | ✓ | 950(e) |
| Citric acid, monohydrate | Citric acid, monohydrate | 5949-29-1 | ✓ | ✓ | 950(e) |
| Citrus meal | Citrus meal | N/A | ✓ | ✓ | 950 |
| Citrus pectin | Citrus pectin | 9000-69-5 | ✓ | | |
| Citnis pulp | Citrus pulp | 68514-76-1 | ✓ | ✓ | 950(b) |
| Clam shells | Clam shells | N/A | ✓ | | |
| Cocoa | Cocoa | 8002-31-1 | ✓ | ✓ | (950(a) |
| Cocoa shell flour | Cocoa shell flour | N/A | ✓ | | |
| Cocoa shells | Cocoa shells | N/A | ✓ | ✓ | 950(b) |
| Cod-liver oil | Cod-liver oil | 8001-69-2 | ✓ | ✓ | 910 |
| Coffee grounds | Coffee grounds | 68916-18-7 | ✓ | ✓ | 950(e) |
| Cookies | Cookies | N/A | ✓ | ✓ | 950 or 1071 |
| Cork | Cork | 61789-98-8 | ✓ | | |
| Corn cobs | Corn cobs | N/A | ✓ | ✓ | 950(b) |
| Cotton | Cotton | N/A | ✓ | | |
| Cottonseed meal | Cottonseed meal | 68424-10-2 | ✓ | | |
| Cracked wheat | Cracked wheat | N/A | ✓ | ✓ | 1071 |
| Decanoic acid, monoester | Decanoic acid, monoester with | 26402-22-2 | ✓ | ✓ | 910 |
| with 1,2,3- propanetriol | 1,2,3- propanetriol | | | | |
| Dextrins | Dextrins | 9004-53-9 | ✓ | ✓ | 950(e) |
| Diglyceryl monooleate | 9-Octadecenoic acid, ester with | 49553-76-6 | ✓ | ✓ | 910 |
| | 1,2,3- propanetriol | | | | |
| Diglyceryl monostearate | 9-Octadecanoic acid, monoester | 12694-22-3 | ✓ | ✓ | 1910 |
| | with oxybis(propanediol) | | | | |
| Dilaurin | Dodecanoic acid, diester with | 27638-00-2 | ✓ | ✓ | 910 |
| | 1,2,3- propanetriol | | | | |
| Dipalmitin | Hexadecanoic acid, diester with | 26657-95-4 | ✓ | ✓ | 910 |
| | 1,2,3- propanetriol | | | | |
| Dipotassium citrate | Citric acid, dipotassium salt | 3609-96-9 | ✓ | ✓ | 950(e) |
| Disodium citrate | Citric acid, disodium salt | 144-33-2 | ✓ | ✓ | 950(e) |
| Disodium sulfate | Disodium sulfate decahydrate | 7727-73-3 | ✓ | | |
| Diatomaceous earth | Kieselguhr; Diatomite (less than | 61790-53-2 | ✓ | ✓ | 910, 930, 1017 |
| | 1% crystalline silica) | | | | |
| Dodecanoic acid, monoester | Dodecanoic acid, monoester with | 27215-38-9 | ✓ | ✓ | 910 |
| with 1,2,3- propanetriol | 1,2,3- propanetriol | | | | |
| Dolomite | Dolomite | 16389-88-1 | ✓ | ✓ | 910 |
| Douglas fir bark | Douglas fir bark | N/A | ✓ | ✓ | 920 |
| Egg shells | Egg shells | N/A | ✓ | | |
| Eggs | Eggs | N/A | ✓ | ✓ | 1071 |
| (+)-Ethyl lactate | Lactic acid, ethyl ester, (S) | 687-47-8 | ✓ | ✓ | 950(e) |
| Ethyl lactate | Lactic acid, ethyl ester | 97-64-3 | ✓ | ✓ | 950(e) |
| Feldspar | Feldspar | 68476-25-5 | ✓ | | |
| Ferric oxide | Iron oxide (Fe₂O₃) | 1309-37-1 | ✓ | ✓ | 910, 930 |
| Ferrous oxide | Iron oxide (FeO) | 1345-25-1 | ✓ | ✓ | 950(b) |
| Fish meal | Fish meal | N/A | ✓ | ✓ | 1071 |
| Fish oil | Fish oil | 8016-13-5 | ✓ | | |
| Faller's earth | Fuller's earth | 8031-18-3 | ✓ | ✓ | 910 |
| Fumaric acid | Fumaric acid | 110-17-8 | ✓ | ✓ | 950(e) |
| gamma-Cyclodextrin | gamma-Cyclodextrin | 17465-86-0 | ✓ | ✓ | 950(e) |
| Gelatins | Gelatins | 9000-70-8 | ✓ | ✓ | 950(a) |
| Gellan gum | Gellan gum | 71010-52-1 | ✓ | ✓ | 950(e) |
| Glue | Glue (as depolymd. animal | 68476-37-9 | ✓ | | |
| | collagen) | | | | |
| Glycerin | 1,2,3-Propanetriol | 56-81-5 | ✓ | ✓ | 950(e) |
| Glycerol monooleate | 9-Octadecenoic acid (Z)-, 2,3- | 111-03-5 | ✓ | ✓ | 910 |
| | dihydroxypropyl ester | | | | |
| Glyceryl dicaprylate | Octanoic acid, diester with 1,2,3- | 36354-80-0 | ✓ | ✓ | 910 |
| | propanetriol | | | | |
| Glyceryl dimyristate | Tetradecanoic acid, diester with | 53563-63-6 | ✓ | ✓ | 910 |
| | 1,2,3- propanetriol | | | | |
| Glyceryl dioleate | 9-Octadecenoic acid (9Z)-, diester | 25637-84-7 | ✓ | ✓ | 910 |
| | with 1,2,3-propanetriol | | | | |
| Glyceryl distearate | Octadecanoic acid, diester with | 1323-83-7 | ✓ | ✓ | 910 |
| | 1,2,3- propanetriol | | | | |
| Glyceryl monomyristate | Tetradecanoic acid, monoester with | 27214-38-6 | ✓ | ✓ | 910 |
| | 1,2,3-propanetriol | | | | |
| Glyceryl monooctanoate | Octanoic acid, monoester with | 26402-26-6 | ✓ | ✓ | 910 |
| | 1,2,3- propanetriol | | | | |
| Glyceryl monooleate | 9-Octadecenoic acid (9Z)-, | 25496-72-4 | ✓ | ✓ | 910, 930 |
| | monoester with 1,2,3-propanetriol | | | | |
| Glyceryl monostearate | Octadecanoic acid, monoester with | 31566-31-1 | ✓ | ✓ | 910, 930 |
| | 1,2,3-propanetriol | | | | |
| Glyceryl stearate | Octadecanoic acid, ester with | 11099-07-3 | ✓ | ✓ | 910 |
| | 1,2,3- propanetriol | | | | |
| Granite | Granite | N/A | ✓ | ✓ | 910 |
| Graphite | Graphite | 7782-42-5 | ✓ | ✓ | 910 |
| Guar gum | Guar gum | 9000-30-0 | ✓ | ✓ | 950(e) |
| Gum Arabic | Gum arabic | 9000-01-5 | ✓ | ✓ | 910 |
| Gum tragacanth | Gum tragacanth | 9000-65-1 | ✓ | | |
| Gypsum | Gypsum | 13397-24-5 | ✓ | ✓ | 910, 930 |
| Hematite | Hematite (Fe₂O₃) | 1317-60-8 | ✓ | | |
| Humic acid | Humic acid | 1415-93-6 | ✓ | ✓ | 950(e) |
| Hydrogenated | Hydrogenated cottonseed oil | 68334-00-9 | ✓ | ✓ | 950(c) |
| Hydrogenated rapeseed | Hydrogenated rapeseed oil | 84681-71-0 | ✓ | ✓ | 950(c) |
| Hydrogenated soybean | Hydrogenated soybean oil | 8016-70-4 | ✓ | ✓ | 950(c) |
| Hydroxyethyl cellulose | Cellulose, 2-hydroxyethyl ether | 9004-62-0 | ✓ | ✓ | 950(e) |
| Hydroxypropyl cellulose | Cellulose, 2-hydroxypropyl ether | 9004-64-2 | ✓ | ✓ | 950(e) |
| Hydroxypropyl methyl | Cellulose, 2-hydroxypropyl methyl | 9004-65-3 | ✓ | ✓ | 950(e) |
| cellulose | ether | | | | |
| Iron magnesium oxide | Iron magnesium oxide (Fe₂MgO₄) | 12068-86-9 | ✓ | | |
| Iron oxide, hydrate | Iron oxide (Fe₂O₃), hydrate | 12259-21-1 | ✓ | ✓ | 910 |
| Iron oxide | Iron oxide (Fe₃O₄) | 1317-61-9 | ✓ | ✓ | 910 |
| Isopropyl alcohol | 2-Propanol | 67-63-0 | ✓ | ✓ | 950(e) |
| Isopropyl myristate | Isopropyl myristate | 110-27-0 | ✓ | ✓ | 910, 930 |
| Kaolin | Kaolin | 1332-58-7 | ✓ | ✓ | 910, 930, 1180 |
| Lactose | Lactose | 63-42-3 | ✓ | ✓ | 950(a) |
| Lactose monohydrate | Lactose monohydrate | 64044-51-5 | ✓ | ✓ | 950(a) |
| Lanolin | Lanolin | 8006-54-0 | ✓ | ✓ | 950(e) |
| Latex rubber | Latex rubber | N/A | ✓ | | |
| Lauric acid | Lauric acid | 143-07-7 | ✓ | ✓ | 950(e) |
| Lecithins | Lecithins | 8002-43-5 | ✓ | ✓ | 950(e) |
| Licorice extract | Licorice extract | 68916-91-6 | ✓ | ✓ | 950(e) |
| Lime dolomitic | Lime (chemical) dolomitic | 12001-27-3 | ✓ | ✓ | 910 |
| Limestone | Limestone | 1317-65-3 | ✓ | ✓ | 910, 930 |
| Linseed oil | Linseed oil | 8001-26-1 | ✓ | ✓ | 950(c) |
| Magnesium carbonate | Carbonic acid, magnesium salt | 546-93-0 | ✓ | ✓ | 910, 930 |
| | (1:1) | | | | |
| Magnesium benzoate | Magnesium benzoate | 553-70-8 | ✓ | | |
| Magnesium oxide | Magnesium oxide | 1309-48-4 | ✓ | ✓ | 910, 940a, 940c |
| Magnesium oxide silicate | Magnesium oxide silicate | 12207-97-5 | ✓ | ✓ | 9 |
| Magnesium silicate | Magnesium silicate | 1343-88-0 | ✓ | ✓ | 910 |
| Magnesium silicate hydrate | Magnesium silicate hydrate | 1343-90-4 | ✓ | ✓ | 910, 930 |
| Magnesium silicon | Magnesium silicon oxide | 14987-04-3 | ✓ | ✓ | |
| Magnesium stearate | Octadecanoic acid, magnesium salt | 557-04-0 | ✓ | ✓ | 910 |
| Magnesium sulfate | Magnesium sulfate | 7487-88-9 | ✓ | ✓ | 910 |
| Magnesium sulfate | Magnesium sulfate heptahydrate | 10034-99-8 | ✓ | ✓ | 910 |
| heptahydrate | | | | | |
| Malic acid | Malic acid | 6915-15-7 | ✓ | ✓ | |
| Malt extract | Malt extract | 8002-48-0 | ✓ | ✓ | 950(a) |
| Malt flavor | Malt flavor | N/A | ✓ | ✓ | 950(a) |
| Maltodextrin | Maltodextrin | 9050-36-6 | ✓ | ✓ | 950(e) |
| Methylcellulose | Cellulose, methyl ether | 9004-67-5 | ✓ | ✓ | 950(e) |
| Mica | Mica | 12003-38-2 | ✓ | ✓ | 910 |
| Mica-group minerals | Mica-group minerals | 12001-26-2 | ✓ | | |
| Milk | Milk | 8049-98-7 | ✓ | ✓ | 1071 |
| Millet seed | Millet seed | N/A | ✓ | ✓ | 950(a) |
| Mineral oil | Mineral oil (U.S.P.) | 8012-95-1 | ✓ | ✓ | 910, 930 |
| 1-Monolaurin | Dodecanoic acid, 2,3- | 142-18-7 | ✓ | ✓ | 910 |
| | dihydroxypropyl ester | | | | |
| 1-Monomyristin | Tetradecanoic acid, 2,3- | 589-68-4 | ✓ | ✓ | 910 |
| | dihydroxypropyl ester | | | | |
| Monomyristin | Decanoic acid, diester with 1,2,3- | 53998-07-1 | ✓ | | |
| | propanetriol | | | | |
| Monopalmitin | Hexadecanoic acid, monoester with | 26657-96-5 | ✓ | ✓ | 910 |
| | 1,2,3-propanetriol | | | | |
| Monopotassium citrate | Citric acid, monopotassium salt | 866-83-1 | ✓ | ✓ | 950(e) |
| Monosodium citrate | Citric acid, monosodium salt | 18996-35-5 | ✓ | ✓ | 950(e) |
| Montmorillonite | Montmorillonite | 1318-93-0 | ✓ | ✓ | 910, 930 |
| Myristic acid | Myristic acid | 544-63-8 | ✓ | ✓ | 910 |
| Nepheline syenite | Nepheline syenite | 37244-96-5 | ✓ | | |
| Nitrogen | Nitrogen | 7727-37-9 | ✓ | | |
| Nutria meat | Nutria meat | N/A | ✓ | | |
| Nylon | Nylon | N/A | ✓ | | |
| Octanoic acid, potassium salt | Octanoic acid, potassium salt | 764-71-6 | ✓ | ✓ | 910 |
| Octanoic acid, sodium salt | Octanoic acid, sodium salt | 1984-06-1 | ✓ | ✓ | 910 |
| Oleic acid | Oleic acid | 112-80-1 | ✓ | ✓ | 910, 930 |
| Oyster shells | Oyster sbells | N/A | ✓ | | |
| Palm oil | Palm oil | 8002-75-3 | ✓ | ✓ | 950(c) |
| Palm oil, hydrogenated | Palm oil, hydrogenated | 68514-74-9 | ✓ | ✓ | 950(c) |
| Palmitic acid | Hexadecanoic acid | 57-10-3 | ✓ | ✓ | 910 |
| Paper | Paper | N/A | ✓ | ✓ | 950(e) |
| Paraffin wax | Paraffin wax | 8002-74-2 | ✓ | | |
| Peanut butter | Peanut butter | N/A | ✓ | ✓ | 1071 |
| Peanut shells | Peanut shells | N/A | ✓ | ✓ | 950(b) |
| Peanuts | Peanuts | N/A | ✓ | ✓ | 1071 |
| Peat moss | Peat moss | N/A | ✓ | | |
| Pectin | Pectin | 9000-69-5 | ✓ | | |
| Perlite | Perlite | 130885-09-5 | ✓ | | |
| Perlite, expanded | Perlite, expanded | 93763-70-3 | ✓ | | |
| Plaster of paris | Plaster of paris | 26499-65-0 | ✓ | | |
| Polyethylene | Polyethylene | 9002-88-4 | ✓ | ✓ | 910, 930 |
| Polyglyceryl oleate | Polyglyceryl oleate | 9007-48-1 | ✓ | ✓ | 910 |
| Polyglyceryl stearate | Polyglyceryl stearate | 9009-32-9 | ✓ | ✓ | 910, 930 |
| Potassium acetate | Acetic acid, potassium salt | 127-08-2 | ✓ | | |
| Potassium aluminum | Potassium aluminum silicate, | 1327-44-2 | ✓ | ✓ | 910 |
| silicate, anhydrous | anhydrous | | | | |
| Potassium benzoate | Benzoic acid, potassium salt | 582-25-2 | ✓ | | |
| Potassium bicarbonate | Carbonic acid, monopotassium salt | 298-14-6 | ✓ | ✓ | 950(e) |
| Potassium chloride | Potassium chloride | 7447-40-7 | ✓ | ✓ | 950(e) |
| Potassium citrate | Citric acid, potassium salt | 7778-49-6 | ✓ | ✓ | 950(e) |
| Potassium humate | Humic acids, potassium salts | 68514-28-3 | ✓ | ✓ | 950(e) |
| Potassium myristate | Tetradecanoic acid, potassium salt | 13429-27-1 | ✓ | ✓ | 910 |
| Potassium oleate | 9-Octadecenoic acid (9Z)-, | 143-18-0 | ✓ | ✓ | 910 |
| | potassium | | | | |
| Potassium ricinoleate | 9-Octadecenoic acid, 12-hydroxy-, | 7492-30-0 | ✓ | | |
| | monopotassium salt, (9Z, 12R)- | | | | |
| Potassium sorbate | Sorbic acid, potassium salt | 24634-61-5 | ✓ | ✓ | 950(e) |
| Potassium stearate | Octadecanoic acid, potassium salt | 593-29-3 | ✓ | ✓ | 1068 |
| Potassium sulfate | Potassium sulfate | 7778-80-5 | ✓ | ✓ | 910 |
| Potassium sulfate | Sulfuric acid, monopotassium salt | 7646-93-7 | ✓ | | |
| 1,2-Propylene carbonate | 1,3-Dioxolan-2-one, 4-methyl- | 108-32-7 | ✓ | ✓ | 950(e) |
| Pumice | Pumice | 1332-09-8 | ✓ | | |
| Red cabbage color | Red cabbage color (expressed from | N/A | ✓ | ✓ | 950(e) |
| | edible red cabbage heads via a | | | | |
| | pressing process using only | | | | |
| | acidified water) | | | | |
| Red cedar chips | Red cedar chips | N/A | ✓ | | |
| Red dog flour | Red dog flour | N/A | ✓ | | |
| Rubber | Rubber | 9006-04-6 | ✓ | | |
| Sawdust | Sawdust | N/A | ✓ | | |
| Shale | Shale | N/A | ✓ | | |
| Silica, amorphous, fumed | Silica, amorphous, fumed | 112945-52-5 | ✓ | ✓ | 950(e) |
| | (crystalline free) | | | | |
| Silica, amorphous, precipitate | Silica, amorphous, precipitate and | 7699-41-4 | ✓ | ✓ | 950(e) |
| and gel | gel | | | | |
| Silica | Silica (crystalline free) | 7631-86-9 | ✓ | ✓ | |
| Silica gel | Silica gel | 63231-67-4 | ✓ | ✓ | 950(e) |
| Silica gel, precipitated, | Silica gel, precipitated, crystalline- | 12926-00-8 | ✓ | ✓ | 950(e) |
| crystalline-free | free | | | | |
| Silica, hydrate | Silica, hydrate | 10279-57-9 | ✓ | ✓ | 950(e) |
| Silica, vitreous | Silica, vitreous | 50676-86-0 | ✓ | ✓ | 950(e) |
| Silicic acid, magnesium salt | Silicic acid (H₂SiO₃), magnesium | 13776-74-4 | ✓ | ✓ | 910, 930 |
| | salt | | | | |
| Soap | Soap (The water soluble sodium or | N/A | ✓ | ✓ | 950(e) |
| | potassium salts of fatty acids | | | | |
| | produced by either the | | | | |
| | saponification of fats and oils, or | | | | |
| | the neutralization of fatty acid) | | | | |
| Soapbark | Quillaja saponin | 1393-03-9 | ✓ | ✓ | 950(e) |
| Soapstone | Soapstone | 308076-02-0 | ✓ | ✓ | 910, 930 |
| Sodium acetate | Acetic acid, sodium salt | 127-09-3 | ✓ | ✓ | 950(e) |
| Sodium alginate | Sodium alginate | 9005-38-3 | ✓ | ✓ | 950(e) |
| Sodium benzoate | Benzoic acid, sodium salt | 532-32-1 | ✓ | ✓ | 950(e) |
| Sodium bicarbonate | Sodium bicarbonate | 44-55-8 | ✓ | ✓ | 950(e) |
| Sodium carboxymethyl | Cellulose, carboxymethyl ether, | 9004-32-4 | ✓ | ✓ | 950(e) |
| cellulose | sodium | | | | |
| Sodium chloride | Sodium chloride | 7647-14-5 | ✓ | ✓ | 950(e) |
| Sodium citrate | Sodium citrate | 1994-36-5 | ✓ | ✓ | 950(e) |
| Sodium humate | Humic acids, sodium salts | 68131-04-4 | ✓ | ✓ | 950(e) |
| Sodium oleate | Sodium oleate | 143-19-1 | ✓ | ✓ | 910 |
| Sodium ricinoleate | 9-Octadecenoic acid, 12-hydroxy-, | 5323-95-5 | ✓ | | |
| | monosodium salt, (9Z,12R)- | | | | |
| Sodium stearate | Octadecanoic acid, sodium salt | 822-16-2 | ✓ | ✓ | 910 |
| Sodium sulfate | Sodium sulfate | 7757-82-6 | ✓ | ✓ | 910, 930 |
| Sorbitol | D-glucitol | 50-70-4 | ✓ | ✓ | 950(e) |
| Soy protein | Soy protein | N/A | ✓ | | |
| Soya lecithins | Lecithins, soya | 8030-76-0 | ✓ | ✓ | 950(e) |
| Soybean hulls | Soybean hulls | N/A | ✓ | ✓ | 950(b) |
| Soybean meal | Soybean meal | 68308-36-1 | ✓ | ✓ | 1071 |
| Soybean, flour | Soybean, flour | 68513-95-1 | ✓ | ✓ | 1071 |
| Stearic acid | Octadecanoic acid | 57-11-4 | ✓ | ✓ | 910, 930 |
| Sulfur | Sulfur | 7704-34-9 | ✓ | ✓ | |
| Syrups, hydrolyzed | Syrups, hydrolyzed starch, | 68425-17-2 | ✓ | ✓ | 950(e) |
| starch, hydrogenated | hydrogenated | | | | |
| Tetraglyceryl monooleate | 9-Octadecenoic acid (9Z)-, | 71012-10-7 | ✓ | | |
| | monoester with tetraglycerol | | | | |
| Tricalcium citrate | Citric acid, calcium salt (2:3) | 813-94-5 | ✓ | ✓ | 950(e) |
| Triethyl citrate | Citric acid, triethyl ester | 77-93-0 | ✓ | ✓ | 950(e) |
| Tripotassium citrate | Citric acid, tripotassium salt | 866-84-2 | ✓ | ✓ | 950(e) |
| Tripotassium citrate | Citric acid, tripotassium salt, | 6100-05-6 | ✓ | ✓ | 950(e) |
| monohydrate | monohydrate | | | | |
| Trisodium citrate | Citric acid, trisodium salt | 68-04-2 | ✓ | ✓ | 950(e) |
| Trisodium citrate | Citric acid, trisodium salt, | 6132-04-3 | ✓ | ✓ | 950(e) |
| dehydrate | dehydrate | | | | |
| Trisodium citrate | Citric acid, trisodium salt, | 6858-44-2 | ✓ | ✓ | 950(e) |
| pentahydrate | pentahydrate | | | | |
| Ultramarine blue | C.I. Pigment Blue 29 | 57455-37-5 | ✓ | ✓ | 1950(e) |
| Urea | Urea | 57-13-6 | ✓ | ✓ | 950(e) |
| Vanillin | Benzaldehyde, 4-hydroxy-3- | 121-33-5 | ✓ | ✓ | 950(e) |
| | methoxy- | | | | |
| Vermiculite | Vermiculite | 1318-00-9 | ✓ | ✓ | 910 |
| Vinegar | Vinegar (maximum 8% acetic | 8028-52-2 | ✓ | ✓ | 950(a) |
| | acid in solution) | | | | |
| Vitamin C | L-Ascorbic acid | 50-81-7 | ✓ | ✓ | 950(e) |
| Vitamin E | Vitamin E | 406-18-4 | ✓ | ✓ | 910 |
| Walnut flour | Walnut flour | N/A | ✓ | | |
| Walnut shells | Walnut shells | N/A | ✓ | ✓ | 950(b) |
| Wheat | Wheat | N/A | ✓ | ✓ | 1071 |
| Wheat flour | Wheat flour | N/A | ✓ | ✓ | 1071 |
| Wheat germ oil | Wheat germ oil | 8006-95-9 | ✓ | ✓ | 950(c) |
| Wheat oil | Oils, wheat | 58917-73-7 | ✓ | ✓ | 1071 |
| Whey | Whey | 92129-90-3 | ✓ | ✓ | 1071 |
| White mineral oil | White mineral oil (petroleum) | 8042-47-5 | ✓ | ✓ | 910, 930 |
| Wintergreen oil | Wintergreen oil | 68917-75-9 | ✓ | | |
| Wollastonite | Wollastonite (Ca(SiO₃)) | 13983-17-0 | ✓ | | |
| Wool | Wool | N/A | ✓ | | |
| Xanthan gum | Xanthan gum | 11138-66-2 | ✓ | ✓ | 950(e) |
| Yeast | Yeast | 68876-77-7 | ✓ | ✓ | 950(a) |
| Zeolites | Zeolites (excluding erionite | 1318-02-1 | ✓ | ✓ | 910 |
| | (CAS Reg. No. 66733-21-9)) | | | | |
| Zeolites, NaA | Zeolites, NaA | 68989-22-0 | ✓ | | |
| Zinc iron oxide | Zinc iron oxide | 12063-19-3 | ✓ | | |
| Zinc oxide | Zinc oxide (ZnO) | 1314-13-2 | ✓ | ✓ | 910, 930 |
| Zinc stearate | Octadecanoic acid, zinc sal₁ | 557-05-1 | ✓ | ✓ | 920, 930 |

| If the tolerance exemption | Then the inert ingredient may be included in a |
|---|---|
| appears in . . . | minimum risk product that is applied to: |
| 40 CFR180.910 | Growing crops or raw agricultural commodities after |
| | harvest. |
| 40 CFR 180.920 | Growing crops |
| 40 CFR 180.930 | Animals |
| 40 CFR 180.940(a) | Food-contact surfaces in public eating places, dairy- |
| | processing equipment, and food-processing equipment |
| | and utensils |
| 40 CFR 180.940(b) | Dairy-processing equipment, and food-processing |
| | equipment and utensils |
| 40 CFR 180.940(c) | Food-processing equipment and utensils |
| 40 CFR 180.950 | Any food-use site |
| 40 CFR 180.960 | Any food-use site |
| 40 CFR 180.1071 | One of the 14 specified use patterns appropriate for |
| | peanuts, tree nuts, milk, soybeans, eggs, fish, |
| | crustacea, and wheat. |

^{/2}This guidance does not create any binding requirements, although it refers to existing statutory and regulatory requirements and guidance. The guidance is not intended to and cannot be relied on to create rights, substantive or procedural, enforceable by any party in litigation with the United States. The producer is responsible to carefully read the criteria and make an evaluation of how the product meets (or does not meet) the criteria for the minimum risk exemption at 40 CFR 152.25(f) and tolerance and tolerance exemptions at 40 CFR 180.

What is claimed is:

1. A formulation for disinfecting, cleaning, and deodorizing and comprising, in weight percent:
citric acid (50% active) in an amount ranging from about 3.78 to about 4.53%;
isopropanol (100% active) in an amount ranging from about 16.59 to about 20.27%;
sodium lauryl sulfate (30% active) in an amount ranging from about 4.5 to 5.5%;
wintergreen oil in an amount ranging from about 0.207 to about 0.253%;
thyme oil in an amount ranging from about 0.17 to about 0.21%;
cedarwood oil in an amount ranging from about 0.027 to about 0.033%; and
water in an amount ranging from 64.8 to 79.2%.

2. The formulation of claim 1, wherein the pH is between 6.0 and 8.0.

3. The formulation of claim 1, wherein the citric acid (50% active) ranges from about 3.92 to about 4.32%, the isopropanol (100% active) ranges from about 17.51 to about 19.36%, the sodium lauryl sulfate (30% active) ranges from about 4.75 to about 5.25%. and the water ranges from about 69.84 to about 77.16%.

4. The formulation of claim 1, wherein the citric acid (50% active) is 4.12%, the isopropanol (100% active) is 18.43%, the sodium lauryl sulfate (30% active) is 5.0%, the wintergreen oil is 0.23%, the thyme oil is 0.19%, the cedarwood oil is 0.03% and water is 72%.

5. The formulation of claim 1, wherein the formulation has a greater than or equal to 6 log reduction against Pseudomonas aeruginosa (ATCC 15442), Salmonella enterica (ATCC 10708), and Staphylococcus aureus (ATCC 6538).

6. The formulation of claim 1, wherein the formulation has a greater than or equal to 5 log reduction against Human Corona Virus (ATCCVR-740), Norovirus ((Norwalk-like Virus))((Feline Calicivirus)) {(VR-782), Polio Virus Type 1 (ATCC VR-1562), SARS-Related Coronavirus 2 (SARS-CoV-2), and Trichophyton mentagrophytes (ATCC 9533).

7. The formulation of claim 1, wherein the formulation is a microemulsion.

8. The formulation of claim 1, wherein the formulation is a diluted formulation with an additional amount of water for effective cleaning, preferably, the additional amount of water ranges from 1 to 16 ounces of formulation per gallon of added water.

9. A method of disinfecting, cleaning, and/or deodorizing a hard non-porous surface comprising applying the formulation of claim 1 to one or more hard non-porous surfaces.

10. The method of claim 8, wherein the formulation is applied using one or more of brushing, wiping using an implement like a sponge, rag, paper towel, or the like, spraying, foaming, and brooming.

11. The method of claim 9, wherein the formulation is diluted with an additional amount of water for cleaning purposes, preferably with the additional amount of water being in a dilution rate range of 1 ounce to 16 ounces of formulation per gallon of water, more preferably 2 to 4 ounces of formulation per gallon of water.
